(19) United States
(12) Patent Application Publication
(10) Pub. No.: US 2011/0081133 A1
(43) Pub. Date: Apr. 7, 2011

(54) METHOD AND SYSTEM FOR A FAST CHANNEL CHANGE IN 3D VIDEO

(76) Inventors: Xuemin Chen, Rancho Santa Fe, CA (US); Samir Hulyalkar, Newtown, PA (US); Marcus Kellerman, San Diego, CA (US); Ilya Klebanov, Thornhill (CA)

(21) Appl. No.: 12/573,771

(22) Filed: Oct. 5, 2009

(51) Int. Cl. H04N 7/26; H04N 13/00; H04N 7/12; H04N 5/783; H04N 5/917; H04N 11/02

(52) U.S. Cl. 386/356; 348/43; 375/240.01; 375/E07.076; 348/E13.001; 386/343

(57) ABSTRACT

Receiver receives a compressed 3D video comprising a base view video and an enhancement view video. The video receiver determines a random access that occurs at a two-view misaligned base view RAP to start decoding activities on the received compressed 3D video based on a corresponding two-view aligned random access point (RAP). The corresponding two-view aligned RAP is adjacent to the two-view misaligned base view RAP. Pictures in the received compressed 3D video are buffered for the two-view misaligned base view RAP to be decoded staring from the corresponding two-view aligned RAP. One or more pictures in the enhancement view video are interpolated based on the two-view misaligned base view RAP. The video receiver selects a portion of the buffered pictures to be decoded to facilitate a trick mode in personal video recording (PVR) operations for random access at the two-view misaligned RAP.

### CROSS-REFERENCE TO RELATED APPLICATIONS/INCORPORATION BY REFERENCE

This application makes reference to:

U.S. Provisional application Ser. No. ______ (Attorney Docket Number 20677US01) filed on even date herewith [or actual date];
U.S. Provisional application Ser. No. ______ (Attorney Docket Number 20678US01) filed on even date herewith [or actual date];
U.S. Provisional application Ser. No. ______ (Attorney Docket Number 20679US01) filed on even date herewith [or actual date];
U.S. Provisional application Ser. No. ______ (Attorney Docket Number 20680US01) filed on even date herewith [or actual date];
U.S. Provisional application Ser. No. ______ (Attorney Docket Number 20681 US01) filed on even date herewith [or actual date];
U.S. Provisional application Ser. No. ______ (Attorney Docket Number 20682US01) filed on even date herewith [or actual date];
U.S. Provisional application Ser. No. ______ (Attorney Docket Number 20683US01) filed on even date herewith [or actual date];
U.S. Provisional application Ser. No. ______ (Attorney Docket Number 20684US01) filed on even date herewith [or actual date];
U.S. Provisional application Ser. No. ______ (Attorney Docket Number 20685US01) filed on even date herewith [or actual date];
U.S. Provisional application Ser. No. ______ (Attorney Docket Number 20686US01) filed on even date herewith [or actual date];
U.S. Provisional application Ser. No. ______ (Attorney Docket Number 20687US01) filed on even date herewith [or actual date];
U.S. Provisional application Ser. No. ______ (Attorney Docket Number 20688US01) filed on even date herewith [or actual date];
U.S. Provisional application Ser. No. ______ (Attorney Docket Number 20689US01) filed on even date herewith [or actual date];
U.S. Provisional application Ser. No. ______ (Attorney Docket Number 20690US01) filed on even date herewith [or actual date];
U.S. Provisional application Ser. No. ______ (Attorney Docket Number 20691 US01) filed on even date herewith [or actual date];
U.S. Provisional application Ser. No. ______ (Attorney Docket Number 20692US01) filed on even date herewith [or actual date];
U.S. Provisional application Ser. No. ______ (Attorney Docket Number 20694US01) filed on even date herewith [or actual date];
U.S. Provisional application Ser. No. ______ (Attorney Docket Number 20695US01) filed on even date herewith [or actual date];
U.S. Provisional application Ser. No. ______ (Attorney Docket Number 20696US01) filed on even date herewith [or actual date];
U.S. Provisional application Ser. No. ______ (Attorney Docket Number 20697US01) filed on even date herewith [or actual date]; and
U.S. Provisional application Ser. No. ______ (Attorney Docket Number 20698US01) filed on even date herewith [or actual date].

Each of the above stated applications is hereby incorporated herein by reference in its entirety.

### FIELD OF THE INVENTION

Certain embodiments of the invention relate to video processing. More specifically, certain embodiments of the invention relate to a method and system for a fast channel change in 3D video.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV, a 3D video is often desirable because it is often more realistic to viewers than the 2D counterpart. A 3D video comprises a left view video and a right view video. A 3D video frame may be produced by combining left view video components and right view video components, respectively.

Various video encoding standards, for example, MPEG-1, MPEG-2, MPEG-4, H.263, and H.264/AVC, have been established for encoding digital video sequences in a compressed manner. A frame in a compressed video may be coded in three possible modes: I-picture, P-picture, and B-picture. Compressed video frames may be divided into groups of pictures (GOPs). Each GOP comprises one I-picture, several P-pictures and/or several B-pictures for transmission.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a fast channel change in 3D video, substantially as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram of an exemplary video coding system that is operable to facilitate a fast channel change in a 3D video, in accordance with an embodiment of the invention.

FIG. 2 is a diagram illustrating an exemplary video reception unit that is operable to achieve a fast channel change in a 3D video, in accordance with an embodiment of the invention.

FIG. 3 is an exemplary compressed 3D video with misaligned base view random access points that is decoded based on associated two-view aligned random points, in accordance with an embodiment of the invention.

FIG. 4 is a flow chart illustrating exemplary steps that are used to achieve a fast channel change for a compressed 3D video with misaligned base view random access points, in accordance with an embodiment of the invention.

### DETAILED DESCRIPTION OF THE INVENTION

Certain embodiments of the invention may be found in a method and/or system for achieving a fast channel change in 3D video. In various embodiments of the invention, a video receiver is operable to receive a compressed 3D video comprising a base view video and an enhancement view video. The base view video and the enhancement view video each may comprise a plurality of compressed pictures and one or more random access points (RAPs) for random access. The RAPs in the base view video may be two-view aligned or misaligned. The video receiver may be operable to determine when a random access occurs at a two-view misaligned base view RAP for the received compressed 3D video. A two-view misaligned base view RAP may indicate a base view RAP that is misaligned in time with at least one RAP in the enhancement view. In instances when a random access may occur at a two-view misaligned base view RAP, the video receiver may be operable to start decoding activities on the received compressed 3D video based on a corresponding associated two-view aligned RAP.

The associated two-view aligned RAP may be an adjacent two-view aligned RAP of the two-view misaligned base view RAP. Pictures in the base view video and the enhancement view video may be buffered for the two-view misaligned base view RAP staring from the associated two-view aligned RAP. The video receiver may be operable to start decoding the buffered pictures for random access at the two-view misaligned base view RAP. One or more pictures in the enhancement view video may be interpolated based on temporal information indicated by the two-view misaligned base view RAP. The video receiver may be operable to select a portion of the buffered pictures in the base view and enhancement view videos to facilitate, for example, a trick mode in personal video recording (PVR) operations for random access at the two-view misaligned RAP.

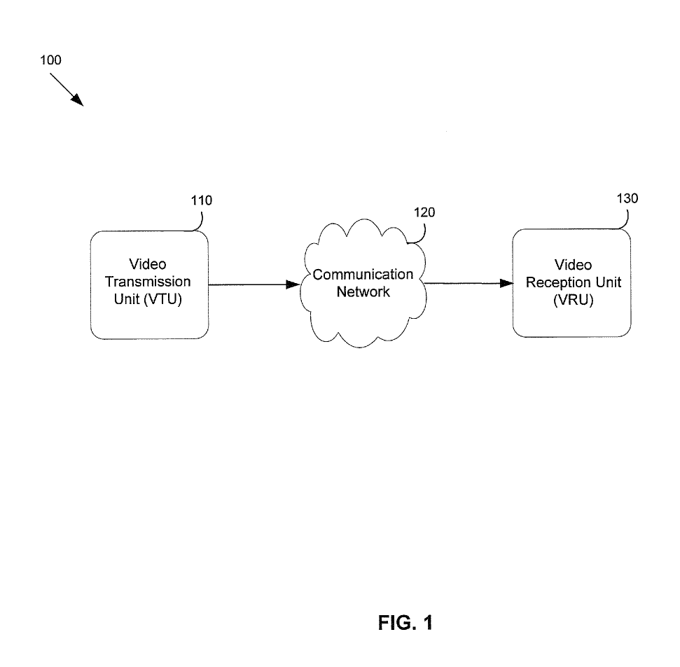

FIG. 1 is a block diagram of an exemplary video coding system that is operable to facilitate a fast channel change in a 3D video, in accordance with an embodiment of the invention, in accordance with an embodiment of the invention. Referring to FIG. 1, there is shown a video transmission unit (VTU) 110, a communication network 120 and a video reception unit (VRU) 130.

The VTU 110 may comprise suitable logic, circuitry, interfaces and/or code that may be operable to provide compressed video content to the VRU 130. The VTU 110 may be operable to acquire an uncompressed 3D source video, which comprises a left view video and a right view video. The VTU 110 may be operable to compress the acquired 3D source video into two coding view videos, namely, a base view video and an enhancement view video using, for example, MPEG-4 Multi-view Video Coding (MVC) standard. Each coding view video may comprise a plurality of compressed pictures such as, for example, intra pictures (I-pictures), predictive pictures (P-pictures), and/or bi-directionally predictive pictures (B-pictures). One or more random access points (RAPs) may be generated in each coding view video. A RAP in a coding view video may be effectively a location within the coding view video and may comprise information that may be used to facilitate random access of the coding view video. The RAPs in the base view video and the enhancement view video may be two-view aligned or misaligned. For example, a two-view aligned RAP, for example, in the base view video may correspond to a base view RAP that is aligned in time with a RAP in the enhancement view. A two-view misaligned RAP, for example, in the base view video may correspond to a base view RAP that is misaligned in time with at least one RAP in the enhancement view. In 3D video, a random access process may be performed according to associated one or more channel change RAPs. A channel change RAP of the compressed 3D video is a base view RAP. A channel change RAP of the compressed 3D video may be selected or determined whenever there is a need to facilitate random access of the base view video and the enhancement view video. The VTU 110 may be operable to multiplex the base view video and the enhancement view video into a single transport stream. The transport stream may be communicated to the VRU 130 via the communication network 120 to support various applications such as, for example, TV broadcasting and fast forward/fast backward functions in video playback.

The communication network 120 may comprise suitable logic, circuitry, interfaces and/or code that may be operable to provide platforms for communication between the VTU 110 and the VRU 130. The communication network 120 may be implemented as a wired or wireless communication network. The communication network 120 may be local area network, wide area network, the Internet, and the like.

The VRU 130 may comprise suitable logic, circuitry, interfaces and/or code that may be operable to receive a transport stream from the VTU 110 over the communication network 120. The received transport stream may comprise multiple coding view videos such as a base view video and an enhancement view video of a compressed 3D video. Each coding view video may comprise a plurality of compressed pictures and one or more RAPs. A RAP of a coding view video may comprise information that may be used to ascertain when to access the coding view video to start decoding functions. The RAPs in the base view video may be two-view aligned or misaligned. The VRU 130 may be operable to associate each two-view misaligned base view RAP with a corresponding two-view aligned RAP such as an adjacent two-view aligned RAP. For each two-view misaligned base view RAP, the VRU 130 may be operable to allocate memory to buffer pictures in both the base view video and the enhancement view video according to an associated two-view aligned RAP. The VRU 130 may be operable to determine or select a channel change RAP point when need. In instances where the determined channel change RAP may occur on a two-view misaligned base view RAP, the VRU 130 may be operable to start decoding buffered pictures based on a corresponding associated two-view aligned RAP for random access at the two-view misaligned base view RAP. Accordingly, the VRU 130 may be operable to perform or present applications such as a channel change and/or PVR trick modes on the received compressed 3D video according to one or more associated two-view aligned RAPs. Examples of the VRU 130 may comprise, for example, set-top boxes, personal computers, and the like.

In an exemplary operation, the VTU 110 may be operable to acquire an uncompressed 3D video. The acquired uncompressed 3D video may comprise a left view video and a right view video. The VTU 110 may be operable to use MPEG-4 MVC standard to compress the acquired uncompressed 3D video into a base view video and an enhancement view video, each comprises a plurality of compressed pictures and one or more RAPs. The one or more RAPs in the base view video and the enhancement view video may be two-view aligned or misaligned. The VTU 110 may be operable to multiplex the base view video and the enhancement view video into a single transport stream to communicate to the VRU 130 via the communication network 120. The VRU 130 may be operable to associate each two-view misaligned base view RAP with an adjacent two-view aligned RAP. Pictures in both the base view video and the enhancement view video may be buffered for each two-view misaligned base view RAP starting from a corresponding associated two-view aligned RAP. The VRU 130 may be operable to determine a channel change RAP (a base view RAP) when need. The VRU 130 may be operable to ascertain when to access the transport stream to start decoding activities based on the determined channel change RAP. In instances where the determined channel change RAP may coincide with a two-view misaligned base view RAP, the VRU 130 may be operable to start decoding buffered pictures based on a corresponding associated two-view aligned RAP for random access at the two-view misaligned base view RAP. Accordingly, function such as fast forward/fast reverse in video playback may be performed starting from the associated two-view aligned RAP to achieve a fast channel change.

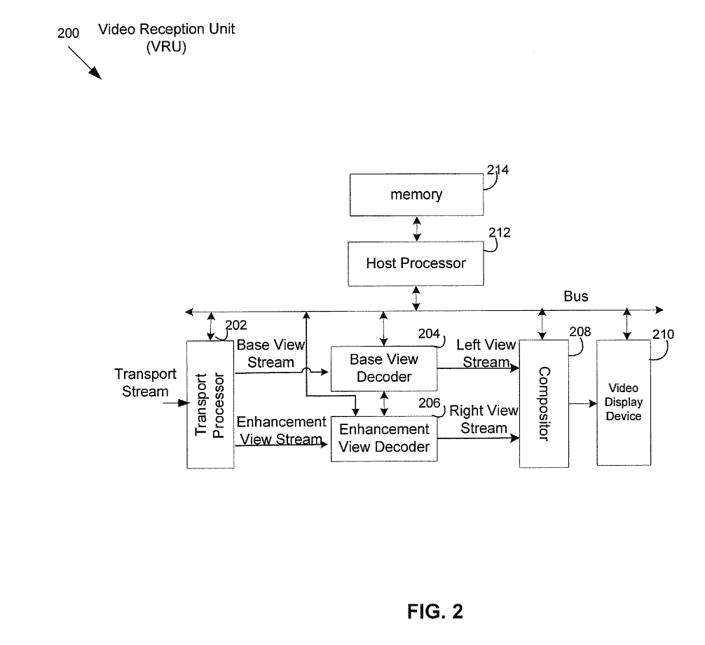

FIG. 2 is a diagram illustrating an exemplary video reception unit that is operable to achieve a fast channel change in a 3D video, in accordance with an embodiment of the invention. Referring to FIG. 2, there is shown a video reception unit (VRU) 200. The VRU 200 comprises a transport processor 202, a base view decoder 204, an enhancement view decoder 206, a compositor 208, a video display device 210, a host processor 212 and a memory 214.

The transport processor 202 may comprise suitable logic, circuitry, interfaces and/or code that may be operable to demultiplex or parse a transport stream received from the VTU 110, for example. The received transport stream is a compound stream comprising a plurality of video streams such as, for example, a base view video stream and an enhancement view video stream of a compressed 3D video. The transport processor 202 may be operable to extract the base view video stream and the enhancement view video stream from the received transport stream. The base view video stream and the enhancement view video stream each may comprise a plurality of compressed pictures and one or more RAPs. The RAPs in the base view video and the enhancement view video may be two-view aligned or misaligned. The transport processor 202 may be operable to index two-view aligned and misaligned RAPs for random access of the compressed 3D video. The transport processor 202 may also be operable to identify two-view misaligned base view RAPs and associate each identified misaligned base view RAP with a corresponding two-view aligned RAP such as an adjacent two-view aligned RAP. For each identified two-view misaligned base view RAP, the transport processor 202 may be operable to buffer pictures in both the base view video and the enhancement view video into the memory 214 according to a corresponding associated two-view aligned RAP.

In instances where a channel change RAP may occur on a two-view misaligned base view RAP, the transport processor 202 may be operable to communicate with the base view decoder 204 and/or the enhancement view decoder 206 to start decoding buffered pictures associated with a corresponding associated two-view aligned RAP. The transport processor 202 may facilitate random access of the received compressed 3D video with a minimal delay. In addition, in instances where a two-view misaligned base view RAP occurs, the transport processor 202 may use horizontally (time) shifted base view video as a reference to interpolate one or more enhancement view pictures by using temporal information in the base view video, which may be indicated by the two-view misaligned base view RAP.

The base view decoder 204 may comprise suitable logic, circuitry, interfaces and/or code that may be operable to decode base view pictures. The base view decoder 204 may be operable to decode the base view pictures into, for example, a left view video. The base view decoder 204 may be operable to decode the base view pictures based on one or more base view RAPs. The one or more base view RAPs may be two-view aligned or misaligned. In instances when a channel change RAP may be a two-view misaligned base view RAP, the base view decoder 204 may be configured to starting decoding base view pictures buffered in the memory 214. The buffered base view pictures may correspond to an associated two-view aligned RAP of the two-view misaligned base view RAP. The base view decoder 204 may be operable to utilize various video decompression algorithms such as specified in MPEG-4 MVC, AVC, VC1, VP6, and/or other video formats to form decompressed or decoded base view video contents. Information such as the scene information from base view decoding may be communicated with the enhancement view decoder 206 to be used for enhancement view decoding.

The enhancement view decoder 206 may comprise suitable logic, circuitry, interfaces and/or code that may be operable to decode enhancement view pictures. The enhancement view decoder 206 may be operable to decode the enhancement view pictures into, for example, a right view video. The enhancement view decoder 206 may be operable to decode the enhancement view pictures based on one or more enhancement view RAPs. The one or more enhancement view RAPs may be two-view aligned or misaligned. In instances when a channel change RAP may coincide with a two-view misaligned base view RAP, the enhancement view decoder 206 may be configured to starting decoding enhancement view pictures buffered in the memory 214. The buffered enhancement view pictures may correspond to an associated two-view aligned RAP of the two-view misaligned base view RAP. The enhancement view decoder 206 may be operable to utilize various video decompression algorithms such as specified in MPEG-4 MVC, AVC, VC1, VP6, and/or other video formats to form decompressed or decoded enhancement view video contents.

The compositor 208 may comprise suitable logic, circuitry, interfaces and/or code that may be operable to combine the resulting left view and right view pictures into 3D pictures for display at an intended pace on the video display device 210.

The video display device 210 may comprise suitable logic, circuitry, and/or code that may be operable to display 3D video pictures received from the compositor 208.

The host processor 212 may comprise suitable logic, circuitry, interfaces and/or code that may be operable to manipulate and control operations of associated operation units such as, for example, the transport processor 202, for example, to achieve a fast channel change in a 3D video to support various applications such as, for example, trick-play modes in a PVR system.

The memory 214 may comprise suitable logic, circuitry, interfaces and/or code that may be operable to store information such as executable instructions and data that may be utilized by the VRU 200. The executable instructions may comprise various image processing functions that may be utilized to process decoded video contents by the base view decoder 204 and the enhancement view decoder 206. The executable instructions may be utilized by the transport processor 202 to, for example, enable fast channel change in 3D video and other functions. The data may comprise received transport stream, two-view aligned RAPs, two-view misaligned base view RAPs, buffered video data for each two-view misaligned base view RAP, and/or decoded video contents. The memory 214 may comprise RAM, ROM, low latency nonvolatile memory such as flash memory and/or other suitable electronic data storage.

In an exemplary operation, the VRU 200 may be operable to receive a transport stream via the transport processor 202 from the VTU 110. The received transport stream may comprise a base view video stream and an enhancement view video stream of a compressed 3D video. The transport processor 202 may be operable to extract the base view and enhancement view video streams from the received transport stream. The extracted base view and enhancement view video streams may each comprise a plurality of compressed pictures and one or more RAPs, which may be two-view aligned or misaligned. The transport processor 202 may be operable to index RAPs and associate each two-view misaligned base view RAP with a corresponding adjacent two-view aligned RAP. For each two-view misaligned base view RAP, the transport processor 202 may be operable to buffer pictures in both the base view video and the enhancement view video into the memory 214 via the host processor 212. The picture buffering may start from a corresponding associated two-view aligned RAP for each misaligned base view RAP. In instances where a channel change RAP of the received compressed 3D video may be a two-view misaligned base view RAP, the base view decoder 204 and/or the enhancement view decoder 206 may be operable to start decoding buffered pictures according to a corresponding associated two-view aligned RAP of the two-view misaligned base view RAP. Accordingly, the VRU 200 may be operable to perform applications such as fast forward/fast backward functions in video playback on the received compressed 3D video according to associated two-view aligned RAPs with a minimal delay.

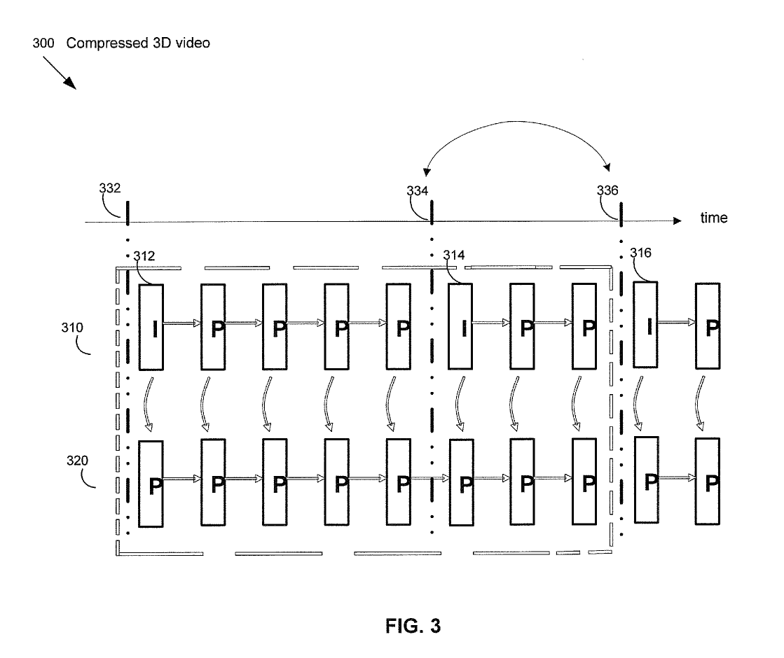

FIG. 3 is an exemplary compressed 3D video with misaligned base view random access points that is decoded based on associated two-view aligned random points, in accordance with an embodiment of the invention. Referring to FIG. 3, there is shown a compressed 3D video 300. The compressed 3D video 300 comprises a base view video 310 and an enhancement view video 320. The base view video 310 and the enhancement video 320 each may comprise one or more RAPs for random access. For example, RAPs 332, 334 and 336 may be RAPs for the base view video 310. The RAPs 332 and 336 may also be RAPs for the enhancement view video 320. The RAP 334 is two-view misaligned. The RAPs 332 and 336 are two-view aligned. A channel change RAP may be selected from available RAPs in the base view video 310 and the enhancement view video 320. The selected channel change RAP may be a two-view aligned RAP such as the RAP 332 and/or the RAP 336. The selected channel change RAP may also be a two-view misaligned RAP such as the RAP 334. In this regard, each two-view misaligned base view RAP such as the RAP 334 may be associated with an adjacent two-view aligned RAP such as the RAP 336. Pictures in the base view video 310 and the enhancement view video 320 may be buffered starting from the associated two-view aligned RAP (the RAP 336) for the misaligned base view RAP (the RAP 334). Functions such as PVR trick mode operation may be performed based on, for example, the associated two-view aligned RAP (the RAP 336) for the selected channel change RAP at the misaligned base view RAP (the RAP 334).

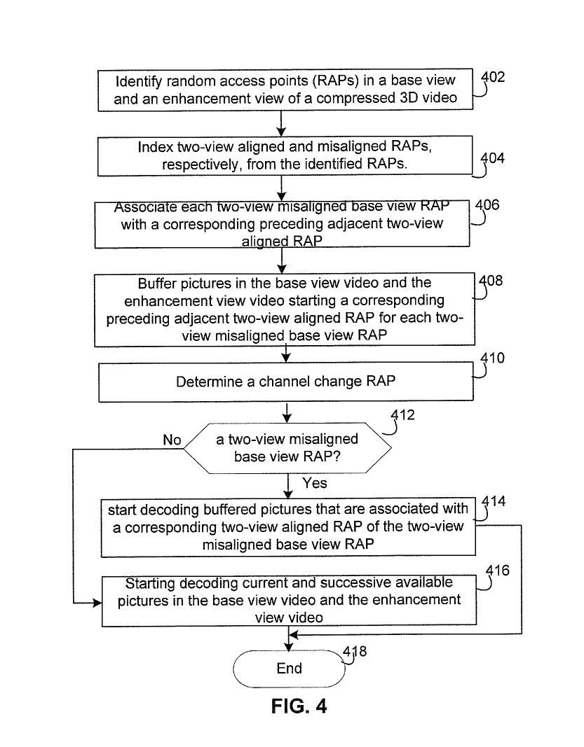

FIG. 4 is a flow chart illustrating exemplary steps for fast channel change for a compressed 3D video with misaligned base view random access points, in accordance with an embodiment of the invention. Referring to FIG. 4, the exemplary steps start with step 402, where the VRU 200 may be operable to receive a compressed 3D video. The received compressed 3D video may comprise a base view video and an enhancement view video. The base view video and the enhancement view video each may comprise a plurality of compressed pictures and one or more RAPs for random access. The transport processor 202 may be operable to identify the RAPs in the base view video and the enhancement view video of the received compressed 3D video. In step 404, the transport processor 202 may be operable to index two-view aligned and misaligned RAPs, respectively, from the identified RAPs. In step 406, each of the two-view misaligned base view RAPs may be associated with a corresponding adjacent two-view aligned RAP.

In step 408, the transport processor 202 may communicate with the host processor 212 to allocate memory in the memory 214 to buffer pictures in the base view video and the enhancement view video for each two-view misaligned base view RAP. The host processor 212 may be operable to buffer pictures into the memory 214 starting from a corresponding associated two-view aligned RAP for each of the two-view misaligned base view RAP. In step 410, the transport processor 202 may be operable to determine a channel change RAP (a base view RAP) when needed. In step 412, it may be determined whether the determined channel change RAP is a two-view misaligned base view RAP. In instances where the determined channel change RAP is a two-view misaligned base view RAP, then in step 414, the transport processor 202 may be operable to communicate with the base view decoder 204 and the enhancement view decoder 206 to start decoding corresponding buffered pictures in the memory 214 based on an associated two-view aligned RAP of the two-view misaligned base view RAP. The exemplary steps may stop in step 418.

In step 412, in instances where the determined channel change RAP is not a two-view misaligned base view RAP, then in step 416, the base view decoder 204 and the enhancement view decoder 206 may be operable to starting decoding current and successive available pictures in the base view video and the enhancement view video, respectively. The exemplary steps may end at step 418.

Exemplary aspects of a method and system for fast channel change in 3D video are provided. In accordance with various exemplary embodiments of the invention, the VRU 200 may be operable to receive a compressed 3D video. The received compressed 3D video may comprise a base view video and an enhancement view video. The base view video and the enhancement view video each may comprise a plurality of compressed pictures and one or more RAPs for random access. RAPs in the base view video may be two-view aligned or misaligned. The VRU 200 may be operable to determine when a random access occurs at a two-view misaligned base view RAP for the received compressed 3D video. In instances when a random access may occur at a two-view misaligned base view RAP such as the base view RAP 314, the VRU 200 may be operable to start decoding activities on the received compressed 3D video based on a corresponding associated two-view aligned RAP. The associated two-view aligned RAP may be an adjacent two-view aligned RAP such as the base view RAP 316. The transport processor 202 may be operable to buffer pictures in the base view video and the enhancement view video for the two-view misaligned base view RAP.

The host processor 212 may be operable to buffer pictures into the memory 214 starting from the two-view misaligned base view RAP. Pictures may be buffered starting from the associated two-view aligned RAP such as the base view RAP 316. The transport processor 202 may be operable to communicate with the base view decoder 204 and the enhancement view decoder 206 to start decoding the corresponding buffered pictures in the memory 214 for random access at the two-view misaligned base view RAP. One or more pictures in the enhancement view video may be interpolated based on temporal information indicated by the two-view misaligned base view RAP. The VRU 200 may be operable to select a portion of the buffered pictures in the base view and enhancement videos to facilitate PVR operations for random access at the two-view misaligned RAP. The VRU 200 may be operable to utilize the decoded portion of the buffered pictures in the base view and enhancement view videos to support various applications a personal video recording (PVR). For example, the decoded portion of the buffered pictures may be repented to viewers using a trick mode operation in PVR.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for a fast channel change in 3D video.

Accordingly, the present invention may be realized in hardware, software, or a combination thereof. The present invention may be realized in a centralized fashion in at least one computer system, or in a distributed fashion where different elements may be spread across several interconnected computer systems. Any kind of computer system or other apparatus adapted for carrying out the methods described herein may be suited. A typical combination of hardware and software may be a general-purpose computer system with a computer program that, when being loaded and executed, may control the computer system such that it carries out the methods described herein. The present invention may be realized in hardware that comprises a portion of an integrated circuit that also performs other functions.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video, the method comprising:
performing by one or more processors and/or circuits:
determining when a random access occurs at a two-view misaligned base view random access point (RAP) for compressed three dimensional (3D) video; and
decoding said compressed 3D video based on a corresponding two-view aligned RAP, when said determination indicates that said random access occurs at a two-view misaligned base view RAP.

2. The method according to claim 1, wherein said corresponding two-view aligned RAP is adjacent to said two-view misaligned base view RAP.

3. The method according to claim 1, wherein said compressed 3D video comprises a base view and an enhancement view.

4. The method according to claim 3, comprising buffering pictures for said base view and said enhancement view according to said corresponding two-view aligned RAP for said two-view misaligned base view RAP.

5. The method according to claim 4, comprising decoding said buffered pictures in said base view and said enhancement view for said random access starting at said two-view misaligned base view RAP.

6. The method according to claim 4, comprising interpolating one or more pictures for said enhancement view based on said two-view misaligned base view RAP.

7. The method according to claim 4, comprising selecting a portion of said buffered pictures in said base view and said enhancement view.

8. The method according to claim 7, comprising decoding said selected portion of said buffered pictures in said base view and said enhancement view for said random access starting at said two-view misaligned base view RAP.

9. The method according to claim 8, wherein said decoded portion of said buffered pictures in said base view and said enhancement view are utilized for personal video recording (PVR).

10. The method according to claim 9, wherein said decoded portion of said buffered pictures in said base view and said enhancement view are utilized for trick modes for said PVR.

11. A system for video coding, the system comprising:
one or more processors and/or circuits for use a video processing system, wherein said one or more processors and/or circuits are operable to:
determine when a random access occurs at a two-view misaligned base view random access point (RAP) for compressed three dimensional (3D) video; and
decode said compressed 3D video based on a corresponding two-view aligned RAP, when said determination indicates that said random access occurs at a two-view misaligned base view RAP.

12. The system according to claim 11, wherein said corresponding two-view aligned RAP is adjacent to said two-view misaligned base view RAP.

13. The system according to claim 11, wherein said compressed 3D video comprises a base view and an enhancement view.

14. The system according to claim 13, wherein said one or more processors and/or circuits are operable to buffer pictures for said base view and said enhancement view according to said corresponding two-view aligned RAP for said two-view misaligned base view RAP.

15. The system according to claim 14, wherein said one or more processors and/or circuits are operable to start decoding said buffered pictures in said base view and said enhancement view for said random access starting at said two-view misaligned base view RAP.

16. The system according to claim 14, wherein said one or more processors and/or circuits are operable to interpolate one or more pictures for said enhancement view based on said two-view misaligned base view RAP.

17. The system according to claim 14, wherein said one or more processors and/or circuits are operable to select a portion of said buffered pictures in said base view and said enhancement view.

18. The system according to claim 17, wherein said one or more processors and/or circuits are operable to start decoding said selected portion of said buffered pictures in said base view and said enhancement view for said random access starting at said two-view misaligned base view RAP.

19. The system according to claim 18, wherein said decoded portion of said buffered pictures in said base view and said enhancement view are utilized for personal video recording (PVR) operations.

20. The system according to claim 19, wherein said decoded portion of said buffered pictures in said base view and said enhancement view are utilized for trick modes for said PVR.
